(19) United States
(12) Patent Application Publication
(10) Pub. No.: US 2006/0104332 A1
(43) Pub. Date: May 18, 2006

(54) APPARATUS AND METHOD FOR DEFINING SYMBOL TIMING WINDOW AND CAPTURING SIGNAL

(76) Inventors: Juinn-Horng Deng, Taoyuan County (TW); Kuang-Shyr Wu, Taoyuan Hsien (TW); Yu-Min Chuang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/905,186

(22) Filed: Dec. 21, 2004

(30) Foreign Application Priority Data
Nov. 15, 2004 (TW) 93134874

(51) Int. Cl. H04B 1/69; H04K 1/10

(52) U.S. Cl. 375/130; 375/260

(57) ABSTRACT

An apparatus and a method of defining symbol timing window and capturing signal are provided for a UWB receiver. The present invention is characterized in delaying a start point of a symbol timing window for a preset time T. According to the symbol timing window, a serial symbol signals are received and each of received symbol signals comprises a prefix signal, a received data signal, and a guard signal. The time period of the prefix signal is T1−T, the time period of the guard signal is T2+T, and T≦T1−T2. In addition, the received data signal and the guard signal are captured, and then the guard signal is added to the received data signal for outputting the added received data signal.

### BACKGROUND OF THE INVENTION

1. Field of the Invention

The present invention relates to a signal capturing method and an apparatus thereof, and more particularly to a signal capturing method and an apparatus thereof by using a multi-band orthogonal-frequency-division-multiplexing ultra-wide band receiver (MB OFDM Ultra-Wide Band receiver).

2. Description of the Related Art

Ultra-wide band (UWB) technology is a present wireless telecommunication technology for short distance wireless data transmission and receiving. The UWB technology has the advantages of low-power consumption, high transmission rate, and low cost so that it can be applied to the high-quality, high-capacity wireless telecommunication. For the high-speed communication among digital apparatuses in houses or offices, the UWB technology provides the accessibility and convenience for wireless telecommunication. In addition, the UWB technology can provide short-distance communication services, such as the transmission of high-quality images, music, and high-capacity data, for wireless personal area networks (WPANs). It also can be applied to the wireless local area networks (WLANs), home networks, and short-distance radars.

In the UWB wireless communication technology, the prior technology used to maintain orthogonality after the fast Fourier transform (FFT) and improve multi-path fading includes following two methods. One is to add cyclic prefix in the frequency signals of the FFT. This approach, however, is vulnerable to create a saw-type harmonic loss. In order to remove the saw-type harmonic loss of the frequency signal generated from the transmitter, adding the cyclic prefix is replaced by adding zero-padded prefix to eliminate the multi-path fading and signal harmonic loss.

In the multi-band orthogonal-frequency-division-multiplexing (MB OFDM) system, the frequency is divided into 14 bands. Each band has a bandwidth about 528 MHz. The bands are sequentially allocated between 3.1 GHz and 10.6 GHz, in order to transmit a series of OFDM symbol signals to the corresponding bands. Wherein, in the specification of the UWB transmitter, the signal period of a OFDM symbol signal is about 312.5 ns for 165 sampling times, which comprises the zero-padded prefix 60.6 ns for 32 sampling times, the data signal 242.4 ns for 128 sampling times, and the guard interval for switching different bands about 9.5 ns for 5 sampling times.

According to the communication theory, the FSS can be normally performed only if the received signals have the circular convolution characteristic. If the circular convolution characteristic is destroyed during the channel transmission, it is called the channel effect. For the UWB receiver, the effect occurred in the channel should be copied to the front of the received signal for normal operation.

Note that the guard interval is just about 9.5 ns in the design specification above. It is so short that the orthogonality of the received signal cannot be maintained. It means that when the channel effect is copied and added to the front of the received signal, the guard interval is too short to cover the effect due to the circular convolution of the signal and the channel. The phenomenon will cause the harmonic loss of the signal. Accordingly, how to completely copy the channel effect to the received signal so that the FFT can be normally performed is very important for maintaining high quality of the signal.

In the UWB receiver, a special technique is required for the time domain despreading operation. The prior art despreading circuit is different from the spreading circuit of the transmitter. The different spreading circuit of the transmitter will increase manufacturing costs. In addition, complexity of the channel compensation mechanism of the prior art receiver is increased. Errors are easy to occur, and the receiver cannot normally function.

### SUMMARY OF THE INVENTION

Accordingly, the present invention is directed to a method for defining a symbol timing window and capturing a signal. The method is adapted for an ultra-wide band (UWB) receiver. By re-defining the start point of the symbol timing window, the issue of the short waiting time confronted in the prior art technology can be overcome.

The present invention is also directed to a signal capturing apparatus. The apparatus is adapted for a UWB receiver. By re-defining the start point of the symbol timing window, the issue of the short waiting time confronted in the prior art technology can be overcome.

The present invention provides a method for defining a symbol timing window and capturing a signal. The method is adapted for an ultra-wide band (UWB) receiver. The UWB receiver receives a series of multi-band orthogonal-frequency-division-multiplexing (MB OFDM) symbol signals transmitted from a UWB transmitter. Each of the MB OFDM symbol signals comprises a zero-padded prefix, a data signal, and a guard interval, wherein a time period of the zero-padded prefix is T1, a time period of the guard interval is T2, T1 is larger than T2, and a sum of time period of the MB OFDM symbol signals is T3. The method for defining the symbol timing window and capturing the signal comprises following steps: delaying for a preset time period T from a start point of the zero-padded prefix, serving as a start point of the symbol timing window, a time period of the symbol timing window being T3, receiving a plurality of received symbol signals according to the symbol timing window, wherein each of the received symbol signals comprises a prefix signal, a received data signal, and a guard signal, a time period of the prefix signal is T1−T, a time period of the guard signal is T2+T, and T≦T1−T2; and capturing the received data signal and the guard signal, adding the guard signal to a front of the received data signal, and outputting the added received data signal.

According to a preferred embodiment of the present invention, the UWB receiver is a MB-OFDM receiver. The MB-OFDM switches bands at the start point of the symbol timing window, and maintains the same band during the symbol timing window.

The present invention provides a signal capturing apparatus. The apparatus is adapted for an ultra-wide band (UWB) receiver. An antenna of the MB-OFDM receiver receives a plurality of MB OFDM symbol signals transmitted from a MB-OFDM transmitter. Each of the MB OFDM symbol signals comprises a zero-padded prefix, a data signal, and a guard interval, wherein a time period of the zero-padded prefix is T1, a time period of the guard interval is T2, T1 is larger than T2, and a sum of time period of the MB OFDM symbol signals is T3. The signal capturing apparatus comprises: a frequency-hopping generator, a frequency mixer, an analog/digital converter, and a symbol timing window capturer. The frequency-hopping generator generates one of a plurality of central frequency signals. The frequency mixer is coupled to the frequency-hopping generator to frequency mix an output from the antenna and an output from the frequency-hopping generator. The analog/digital converter is coupled to an output terminal of the frequency mixer. The symbol timing window capturer is coupled to an output terminal of the analog/digital converter to capture a received data signal and a guard signal, and to add the guard signal to a front of the received data signal to output the added received data signal. Wherein, the signal capturing apparatus delays a start point of the zero-padded prefix for a preset time period T, serving as a start point of the symbol timing window. A time period of the symbol timing window is T3. The frequency-hopping generator switches central frequency signals at the start point of the symbol timing window. The same central frequency signal is outputted during the symbol timing window so that the symbol timing window capturer receives a plurality of received symbol signals. Each of the received symbol signals comprises a prefix signal, a received data signal, and a guard signal. A time period of the prefix signal is T1−T, a time period of the guard signal is T2+T, and T≦T1−T2.

According to a preferred embodiment of the present invention, the preset time T can be T1−T2, for example. It means that the time period of the prefix signal is T2, and a time period of the guard signal is T1.

The signal capturing apparatus and the method thereof according to the present invention changes the start point of the symbol timing window. The present invention replaces the start point of the pre-padded prefix with 60.6 ns with the start point of the guard interval with 9.5 ns. The present invention captures the received data signal with 242.4 ns, after 9.5 ns, for the subsequent fast Fourier transform (FFT) operation. For the UWB receiver, the channel effect can be completed copied to the front of the received data signal to maintain orthogonality of the received data signal to correctly perform the FFT.

The above and other features of the present invention will be better understood from the following detailed description of the preferred embodiments of the invention that is provided in communication with the accompanying drawings. Noted that “couple” means two devices are directly connected to each other, or two devices are connected to each other through a third device. Usually, the third device is a prior art device which will not be shown in figures of the following embodiments.

### BRIEF DESCRIPTION OF THE DRAWINGS

FIG. 1 is a schematic configuration showing a method for defining a symbol timing window and capturing a signal according to an embodiment of the present invention.

FIG. 2 is a schematic block diagram showing a ultra-wide band (UWB) receiver according to an embodiment of the present invention.

FIG. 3 is a curve showing a relationship between the packet error rate (PER) and the signal/noise (E_{b}/Nₒ) ratio.

### DESCRIPTION OF SOME EMBODIMENTS

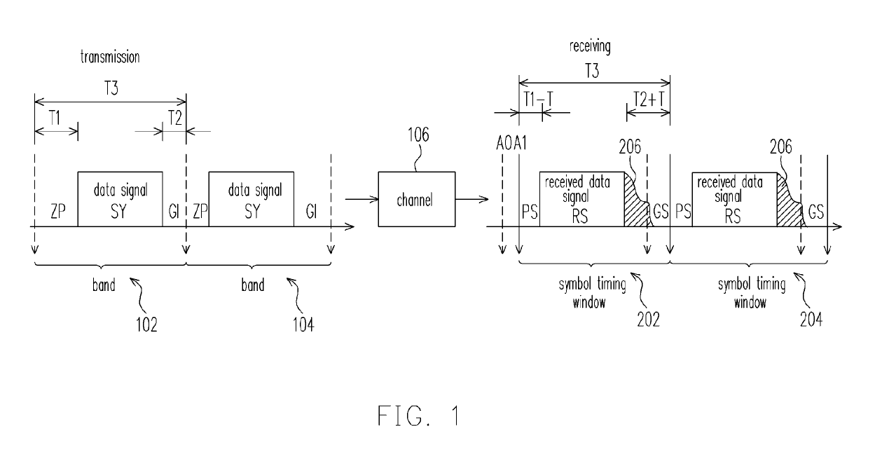

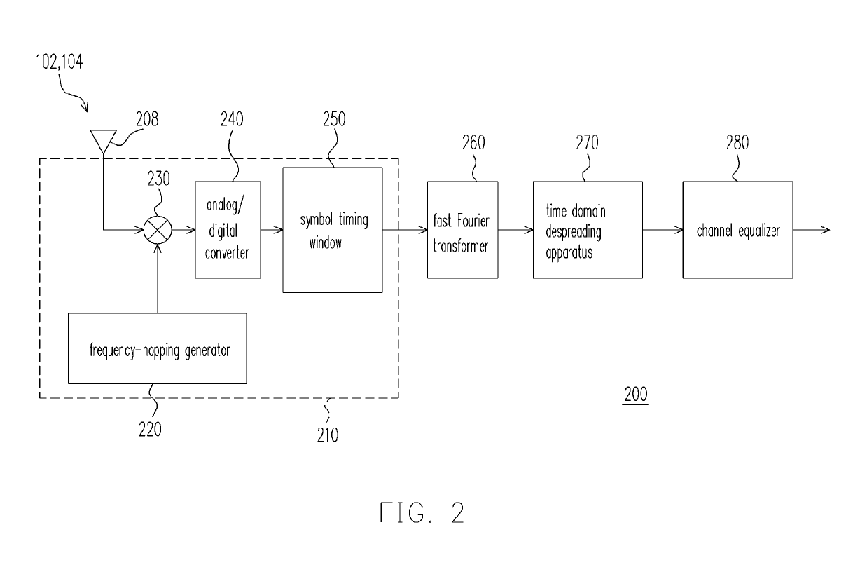

FIG. 1 is a schematic configuration showing a method for defining a symbol timing window and capturing a signal according to an embodiment of the present invention. FIG. 2 is a schematic block diagram showing an ultra-wide band (UWB) receiver according to an embodiment of the present invention.

Referring to FIG. 1, in the embodiment of the multi-band orthogonal-frequency-division-multiplexing (MB-OFDM) data transmission/receiving system, plural serial OFDM symbol signals 102 and 104 are transmitted to a UWB receiver 200 as shown in FIG. 2 through the multi-path channel 106 by the high-frequency data transmission of the carrier waves of the wireless communication technology. Wherein, each of the OFDM symbol signals 102 and 104 corresponds to one of the bands. Each OFDM symbol signal comprises a 60.6-ns zero-padded prefix (ZP) for 32 sampling times, a 242.4-ns data signal SY for 128 sampling times, and a 9.5-ns guard interval (GI) for 5 sampling times for switching bands.

The UWB receiver 200 receives the OFDM symbol signals 102 and 104 according to the definition time and the start point of the symbol timing window. The start point of each symbol timing window serves for the band switching to receive the plural serial symbol signals 202 and 204. Wherein, each of the symbol signals 202 and 204 comprises a prefix signal PS, a received data signal RS, and a guard signal GS. In the prior art technology, the 60.6-ns zero-padded prefix ZP serves as the start point of receiving the symbol signals 202 and 204 by the UWB receiver 200. It is the original start point of the symbol timing window represented by the dot line A0 in FIG. 1. Different from the prior art technology, the present invention delays the start point of the zero-padded prefix ZP for a preset time T, serving as a new start point of the symbol timing window represented by the solid line A1 in FIG. 1. T1 represents the time period of the zero-padded prefix ZP, and T2 represents the time period of the guard interval GI. The time period of the prefix signal PS of each of the received symbol signals 202 and 204 is reduced from T1 to T1−T. The time period of the guard signal GS of each of the received symbol signals 202 and 204 is increased from T2 to T2+T. The total time period of the symbol timing window T3 is fixed. It means that the total time period of each of the OFDM symbol signals 102 and 104 is 312.5 ns.

The zero-padded prefix ZP and the guard interval GI do not serve the function of data signal transmissions, but the guard function for the receiver. Accordingly, even if the start point of the zero-padded prefix ZP does not serve as the start point of each of the received symbol signals 202 and 204, the UWB receiver 200 is not influenced. After the delay for a preset time T for the UWB receiver 200, the new symbol timing window is increased from the 9.5-ns guard interval Gl after the received data signal RS to the time period T2+T to capture the channel effect tail 206 resulting from the channel effect at the end of the received data signal RS. In this embodiment, the time period of the prefix signal PS is T1−T, such as 9.5 ns, for example. The time period of the guard signal GS can be, for example, 60.6 ns. It means that this embodiment of the present invention exchanges the 9.5-ns guard interval Gl with the 60.6-ns zero-padded prefix ZP. The time period of the prefix signal PS can be larger, or equal to 9.5 ns. The guard signal GS can be smaller than 60.6 ns.

Referring to FIG. 2, the method for defining the symbol timing window and capturing data described above is applied to the UWB receiver 200 to perform the data capturing function. The new-created symbol timing window can resolve the prior art issue due to the short guard interval GI. As shown in FIG. 2, the signal capturing apparatus 210 comprises a frequency-hopping generator 220, a frequency mixer 230, an analog/digital converter 240, and a symbol timing window capturer 250. Wherein, an antenna 208 of the UWB 200 receives plural serial OFDM symbol signals 102 and 104 transmitted from a UWB transmitter (not shown). The OFDM symbol signals 102 and 104 are inputted to the frequency mixer 230 and are frequency mixed with the central frequency generated from the frequency-hopping generator 220 to remove the carrier waves and to obtain the actual OFDM symbol signals. Then, the output of the frequency mixer 230 is transmitted to the analog/digital converter 240 and converted into digital signals. The symbol timing window capturer 250 receives the output from the analog/digital converter 240 to remove the zero-padded prefix ZP and the guard interval GI. The symbol timing window capturer 250 adds the guard signal GS to the front of received data signal RS to output the added received data signal RS.

From the descriptions above, the signal capturing apparatus 210 delays the start point of the zero-padded prefix ZP for a preset time T, serving as the start point of a symbol timing window. The frequency-hopping generator 220 switches central frequency signals at the start point of the symbol timing window, and maintains the same central frequency signal during the symbol timing window. The symbol timing window capturer 250 receives plural serial received symbol signals 202 and 204 according to the symbol timing window. Each received symbol signal comprises a prefix signal PS, a received data signal RS and a guard signal GS as shown in FIG. 1. The time period of the prefix signal PS is T1−T, the time period of the guard signal GS is T2+T, and T≦T1−T2. Accordingly, orthogonality of the received symbol signals 202 and 204 can be effectively maintained.

Due to the circular convolution of the received symbol signals 202 and 204, the subsequent fast Fourier transform (FFT) will not cause harmonic loss of the signal and the quality of data transmission can be maintained. After the fast Fourier transformer 260, the signals can be processed by the time domain despreading apparatus 270 and the channel equalizer 280. Wherein, the channel equalizer 280 usually compensates the harmonic loss caused by the intersymbol interference (ISI). Without increasing the power for signal transmission and the bandwidth of the channel, the quality of the transmission channel can be improved by compensating the amplitude and delay of the received signals.

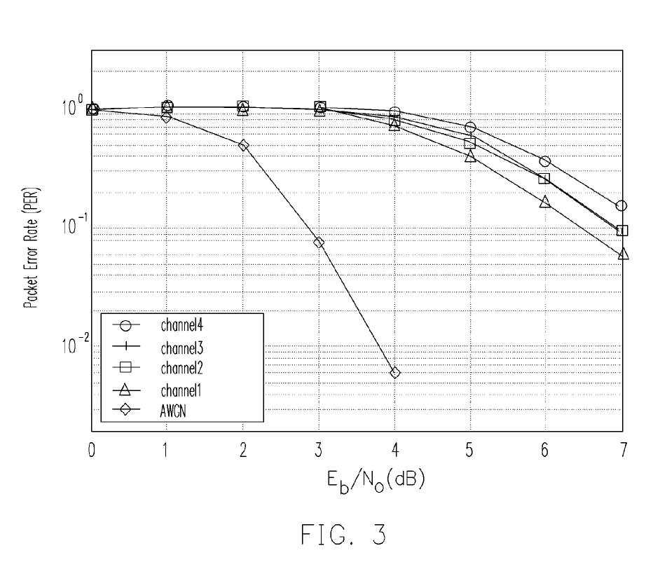

FIG. 3 is a curve showing a relationship between the packet error rate (PER) and the signal/noise (E_{b}/Nₒ) ratio. By simulation, in the UWB system with the 200 Mbps-transmission-rate MB OFDM, the PER can meet the requirement of the specification of the UWB in the environments of the added white gauss noise (AWGN) and the UWB channels CM 1-4.

Accordingly, the signal capturing apparatus and the method thereof according to the present invention changes the start point of the symbol timing window. The present invention replaces the start point of the pre-padded prefix with 60.6 ns with the start point of the guard interval with 9.5 ns. The present invention captures the received data signal with 242.4 ns after 9.5 ns for the subsequent fast Fourier transform (FFT) operation. For the UWB receiver, the channel effect can be completed copied to the front of the received data signal to maintain orthogonality of the received data signal to correctly perform the FFT.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A method for defining a symbol timing window and capturing a signal, the method adapted for a ultra-wide band (UWB) receiver, the UWB receiver receiving a series of multi-band orthogonal-frequency-division-multiplexing (MB OFDM) symbol signals transmitted from a UWB transmitter, each of the MB OFDM symbol signals comprising a zero-padded prefix, a data signal, and a guard interval, wherein a time period of the zero-padded prefix is T1, a time period of the guard interval is T2, T1 is larger than T2, a sum of time period of the MB OFDM symbol signals is T3, and the method for defining the symbol timing window and capturing the signal comprises following steps:
delaying for a preset time period T from an start point of the zero-padded prefix, serving as a start point of the symbol timing window, a time period of the symbol timing window being T3, receiving a plurality of received symbol signals according to the symbol timing window, wherein each of the received symbol signals comprises a prefix signal, a received data signal, and a guard signal, a time period of the prefix signal is T1−T, a time period of the guard signal is T2+T, and T≦T1−T2; and
capturing the received data signal and the guard signal, adding the guard signal to a front of the received data signal, and outputting the added received data signal.

2. The method for defining the symbol timing window and capturing the signal of claim 1, wherein T=T1−T2, and it means that the time period of the prefix signal is T2, and a time period of the guard signal is T1.

3. The method for defining the symbol timing window and capturing the signal of claim 1, wherein the time period T1 of the zero-padded prefix is 60.6 ns, the time period T2 of the guard interval is 9.5 ns, and a period of time T3 of the symbol timing window is 312.5 ns.

4. The method for defining the symbol timing window and capturing the signal of claim 1, wherein the UWB receiver is a MB-OFDM receiver, and the MB-OFDM switches bands at the start point of the symbol timing window, and maintains the same band during the symbol timing window.

5. A signal capturing apparatus, adapted for a MB-OFDM receiver, an antenna of the MB-OFDM receiver receiving a plurality of MB OFDM symbol signals transmitted from a MB-OFDM transmitter, each of the MB OFDM symbol signals comprising a zero-padded prefix, a data signal, and a guard interval, wherein a time period of the zero-padded prefix is T1, a time period of the guard interval is T2, T1 is larger than T2, a sum of time period of the MB OFDM symbol signals is T3, and the signal capturing apparatus comprising:
a frequency-hopping generator to generate one of a plurality of central frequency signals;
a frequency mixer, coupled to the frequency-hopping generator to frequency mix an output from the antenna and an output from the frequency-hopping generator;
an analog/digital converter, coupled to an output terminal of the frequency mixer; and
a symbol timing window capturer, coupled to an output terminal of the analog/digital converter to capture a received data signal and a guard signal, and to add the guard signal to a front of the received data signal to output the added received data signal, wherein the signal capturing apparatus delays a start point of the zero-padded prefix for a preset time period T, serving as a start point of the symbol timing window, a time period of the symbol timing window is T3, the frequency-hopping generator switches central frequency signals at the start point of the symbol timing window, the same central frequency signal is outputted during the symbol timing window so that the symbol timing window capturer receives a plurality of received symbol signals, each of the received symbol signals comprises a prefix signal, a received data signal, and a guard signal, a time period of the prefix signal is T1−T, a time period of the guard signal is T2+T, and T≦T1−T2.

6. The signal capturing apparatus of claim 5, wherein T=T1−T2, and it means that the time period of the prefix signal is T2, and a time period of the guard signal is T1.

7. The signal capturing apparatus of claim 5, wherein the time period T1 of the zero-padded prefix is 60.6 ns, the time period T2 of the guard interval is 9.5 ns, and a period of time T3 of the symbol timing window is 312.5 ns.
